(19) United States
(12) Patent Application Publication
(10) Pub. No.: US 2022/0060761 A1
(43) Pub. Date: Feb. 24, 2022

(54) SYSTEM AND METHOD FOR PROCTORING TESTIMONY FROM A REMOTE LOCATION

(71) Applicant: Jean-Paul Lundy, Los Angeles, CA (US)

(72) Inventor: Jean-Paul Lundy, Los Angeles, CA (US)

(21) Appl. No.: 17/409,760

(22) Filed: Aug. 23, 2021

Related U.S. Application Data
(60) Provisional application No. 63/068,536, filed on Aug. 21, 2020.

(51) Int. Cl. H04N 21/2187; H04N 21/845; H04N 21/858; H04L 29/06

(52) U.S. Cl. CPC H04N 21/2187; H04N 21/8453; H04L 65/4069; H04L 65/1083; H04N 21/858

(57) ABSTRACT

The present invention involves a system and method for proctoring testimony, including proctoring a remote deposition, which reduces or eliminates disingenuous conduct and preserves the integrity of the testimony. A server may be configured to host a remote deposition comprising a live video stream between a host device and one or more client devices. The client devices are configured to receive an invite from the server or the host device to join the remote deposition. The invite to a client device of the witness being deposed, includes a link with instructions to access the remote deposition and lock a user interface of the client device during the live video stream. An application executable by the client device of the witness is configured to access the remote deposition, display the live video stream, and lock access to the user interface of the client device during the live video stream.

### PRIORITY NOTICE

The present Non-provisional Application claims priority under 35 U.S.C. § 119 to U.S. Provisional Patent Application with Ser. No. 63/068,536, filed on Aug. 21, 2021, the disclosure of which are incorporated by reference in their entirety.

### TECHNICAL FIELD OF THE INVENTION

The present invention relates in general to a system and method for monitoring or proctoring testimony. More specifically, the present invention relates to a system and method for proctoring testimony, including proctoring a remote deposition, which reduces or eliminates disingenuous conduct and preserves the integrity of the proceeding.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Depositions are litigation tools that involve the taking of sworn, out-of-court oral testimony of a witness, which is reduced to a written transcript for later use in court or for discovery purposes. In some instances, an arbitrator, a magistrate judge, or another appropriate official may be involved during the deposition to make rulings on objections regarding the propriety of the questions from the deposing attorney. More typically however, depositions are conducted outside of court by the parties' lawyers themselves, with no judge present to supervise the examination.

Traditionally, depositions are conducted in a conference or meeting room in which the deposing attorney, the witness being deposed, the witness's attorney, and a court reporter who is authorized to transcribe the deposition and administer the oath of the witness, are all present. However, with the development of live audiovisual communication means over networks such as the Internet, taking the deposition of a witness from a remote location is now possible. In fact, with the impact of the COVID-19 pandemic of 2020, in which many businesses including office spaces were closed, and many were forced to work from home, there was an increase in demand for remote depositions. Similarly, courts begun to use a variety of remote audiovisual tools to hold hearings and other proceedings in lieu of opening the courts to a live audience.

A critical challenge of taking live testimony of a witness, conducting a live hearing, or otherwise conducting a live proceeding in which the integrity of the testimony is of great import, is making sure that the witnesses or participants subject to questioning are not being improperly influenced. This may occur where a witness is improperly provided with access to information during the deposition or proceeding, which inappropriately impacts their testimony. For example, while a witness being examined in a live physical setting can be monitored by a visual inspection (i.e., visually seeing that no notes are being handed to the witness, that the witness is not reading their testimony from cards, reading text messages, or being handed notes, etc.), current remote depositions do not prevent the witness from accessing files, viewing messages, or otherwise gleaning information that may be presented to or accessed by the witness on their monitor during the live deposition. This is because most remote depositions use the cameras of the laptop, desktop, or other computer device to capture the visual of the witness but do not show the witness' screen nor does the depositing attorney have access to the witness' computer or their files.

Accordingly, there is a need for a system and method for remotely proctoring testimony that accounts for the problems with existing systems. It is to these ends that the present invention has been developed.

### SUMMARY OF THE INVENTION

To minimize the limitations in the prior art, and to minimize other limitations that will be apparent upon reading and understanding the present specification, the present invention describes to a software application employing a GUI designed to reduce or eliminate disingenuous conduct during certain testimonial procedures, such as a deposition.

Generally, the present invention involves a system and method for proctoring testimony, including proctoring a remote deposition, which reduces or eliminates disingenuous conduct and preserves the integrity of the testimony. In some aspects of the invention, a server may be configured to host a remote event such as a hearing or deposition that subjects a witness to testimony under oath. The remote event—for example a remote deposition—comprises a live video stream between a host device and one or more client devices. The host device or the server may be configured to send and invite to the client devices. The client devices may be configured to receive an invite from the server or the host device to join the remote deposition. The invite to a client device of the witness being deposed may include a link with instructions to access the remote deposition and lock a user interface of the client device during the live video stream. An application executable by the client device of the witness is configured to access the remote deposition, display the live video stream, and lock access to the user interface of the client device during the live video stream. This prevents the witness-user of the client device from using their keyboard, mouse, touch display interface, or any other user interface of the client device, to glean information on their screen that is outside of the information being presented to the witness during their testimony being taken via the live video stream.

Some aspects of the invention comprise of a system for proctoring a remote deposition. In some embodiments, the system may comprise: a server configured to host a remote deposition comprising a live video stream; a host device; a client device configured to receive an invite from the server or the host device to join the remote deposition, the invite including a link with instructions to access the remote deposition and lock a user interface of the client device during the live video stream; and an application executable by the client device and configured to: access the remote deposition in response to activation of the link; display the live video stream of the remote deposition on the client device, and lock access to the user interface of the client device during the live video stream.

Some aspects of the invention comprise of a method for proctoring a remote deposition. In some embodiments, the method may comprise: sending an invite to a host device to join a remote deposition comprising a live video stream; sending an invite to a client device to join the remote deposition, the invite to the client device including a link with instructions to access the remote deposition and lock a user interface of the client device during the live video stream; launching an application on the client device in response to activation of the link to access the remote deposition, including: displaying the live video stream of the remote deposition on the client device, and locking access to the user interface of the client device during the live video stream.

In some embodiments, a method for proctoring a remote deposition, comprising: accessing a remote deposition in response to activation of a link on an invite from a server or a host device to join the remote deposition, the invite including instructions to access the remote deposition and lock a user interface of a client device during a live video stream of the remote deposition; displaying the live video stream of the remote deposition on the client device, and locking access to the user interface of the client device during the live video stream.

In some exemplary embodiments, a system for monitoring or proctoring testimony from a remote location may include: a server configured to host a deposition between a host device and a client device; and an application stored within the client device and configured to: receive instructions from the host device to enable or disable non-deposition content on the client device; display a deposition session stream on a screen of the client device; and simultaneously enabling or disabling access to the non-deposition pursuant to the instructions from the host device.

In some exemplary embodiments, a method for monitoring or proctoring testimony from a remote location by way of a graphical user interface (GUI) may include: receiving instructions from a host device to enable or disable non-deposition content on a client device that includes the GUI, the host device and the client device communicating via a server on a network; displaying, via the GUI, a deposition session stream on a screen of the client device; and simultaneously with displaying the deposition session stream, enabling or disabling access to the non-deposition pursuant to the instructions from the host device.

In some exemplary embodiments, a graphical user interface (GUI) for monitoring or proctoring testimony from a remote location may include a set of executable instructions configured to: receive instructions from the host device to enable or disable non-deposition content on the client device; display a deposition session stream on a screen of the client device; and simultaneously enabling or disabling access to the non-deposition pursuant to the instructions from the host device.

Various objectives and advantages of the present invention will become apparent from the following description taken in conjunction with the accompanying drawings wherein are set forth, by way of illustration and example, certain embodiments of this invention. The drawings submitted herein constitute a part of this specification, include exemplary embodiments of the present invention, and illustrate various objects and features thereof.

### BRIEF DESCRIPTION OF DRAWINGS

Elements in the figures have not necessarily been drawn to scale in order to enhance their clarity and improve understanding of the various embodiments of the invention. Furthermore, elements that are known to be common and well understood to those in the industry are not depicted in order to provide a clear view of the various embodiments of the invention. The drawings that accompany the detailed description can be briefly described as follows:

FIG. 1 illustrates a system in accordance with an exemplary embodiment of the present invention.

FIG. 2 illustrates a method in accordance with exemplary embodiments of the present invention.

FIG. 3 illustrates a method performed by a system in accordance with exemplary embodiments of the present invention.

FIG. 4 illustrates a method performed by a client device in accordance with exemplary embodiments of the present invention.

FIG. 5-FIG. 10 illustrate exemplary screen outputs of an application in accordance with the present invention.

FIG. 11 illustrates aspects of computing and computer devices in accordance with exemplary embodiments of the present invention.

### DESCRIPTION OF THE INVENTION

In the following discussion that addresses a number of embodiments and applications of the present invention, reference is made to the accompanying figures, which form a part thereof. Depictions are made, by way of illustration, of specific embodiments in which the invention may be practiced; however, it is to be understood that other embodiments may be utilized and changes may be made without departing from the scope of the present invention. Whenever possible, the same reference numbers are used in the drawings and the following description to refer to the same or similar elements.

In the following detailed description, numerous specific details are set forth by way of examples in order to provide a thorough understanding of the relevant teachings. However, it should be apparent to those skilled in the art that the present teachings may be practiced without such details. In other instances, well known structures, components, and/or functional or structural relationship thereof, etc., have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments, whether these features, elements, and/or steps are included or are to be performed in any particular embodiment.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present. The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

While exemplary embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the invention or inventions disclosed herein. Accordingly, the following detailed description does not limit the disclosure. Instead, the proper scope of the disclosure is defined by the appended claims.

The present disclosure relates to, among other things, a system and method for monitoring or proctoring testimony. Exemplary embodiments of the present disclosure are described with reference to the drawings for illustration purposes and are not intended to limit the scope of the present disclosure. In the present disclosure, the term “proctoring” refers to the act of monitoring or overseeing the integrity of the deposition taking environment.

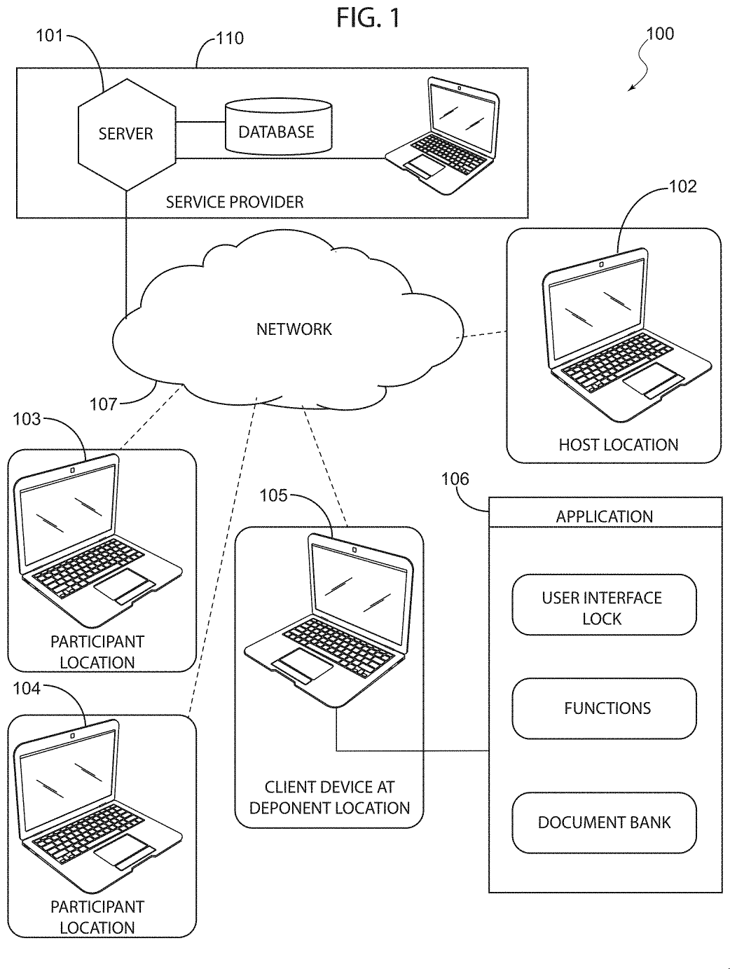

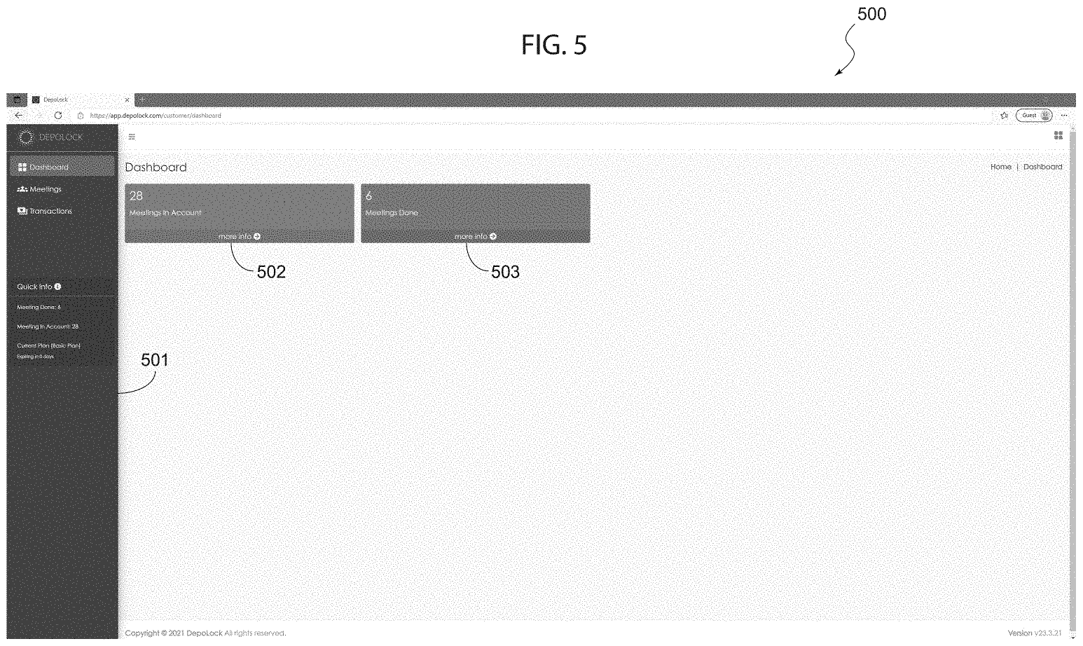

Turning now to the figures, FIG. 1 illustrates a system in accordance with an exemplary embodiment of the present invention. More specifically, this view shows system 100 for proctoring testimony, including proctoring a remote hearing, a remote deposition, or any other procedure in which testimony under oath may be required. System 100 is set up reduce or eliminate disingenuous conduct and preserves the integrity of testimony taken remotely through a network 107, such as the Internet. Generally, system 100 may include a server 101 that is managed or administered by a service provider 110. The service provider may offer services such as remote deposition services by way of providing their clients access to software applications that allow them to order or create and schedule remote events such as remote depositions. Their clients may include solo practitioners and law firms, but also court reporters that are in the regular business of scheduling, conducting, or transcribing testimony taken in certain procedures including during depositions. FIG. 5-FIG. 10 discussed below show several exemplary screen outputs of software or applications that may facilitate services in accordance with practice of exemplary embodiments the present invention.

In some exemplary embodiments, server 101 may be configured to host a remote deposition comprising a live video stream between a host device 102 and one or more client devices 103, 104, and 105. The client devices 103, 104, and 105 may be configured to receive an invite from the server 101 or the host device 102 to join the remote deposition. As will be discussed in more detail below, each of the host device or client device may be any type of computing device without limiting the scope of the present invention. For example, a client or host device may include a desktop computer, a laptop computer, a mobile device such as a tablet, a smartphone, or any other computing device that is capable of audiovisual communication and includes a camera, speaker phones, and microphone. For joining or conducting a remote event such as remote deposition, it may be preferable to have a computing device that facilitates handling files and documents since that is often required for sharing exhibits or other documents during depositions and similar proceedings in which testimony is taken.

The invite to a client device 105 of the witness being deposed, includes a link with instructions to access the remote deposition and lock a user interface of the client device (i.e., a display screen, input device(s) such as a mouse or keyboard or combination device thereof) during the live video stream. In some embodiments, the invite may be generated by the host device 102, or the invite may be generated and distributed by the server 101. For example, in some circumstances the host device may be a computer of the service provider 110. In other embodiments, the service provider 110 may provide an application including a GUI that facilitates the host device with access to a scheduler for creating depositions and invites that are sent from the server 101.

An application 106 may be executable by the client devices 102, 103, 104. Typically, application 106 includes a graphical user interface (GUI) for monitoring or proctoring testimony from a remote location. Application 206 may generally comprise a set of executable instructions configured to: receive instructions from the host device to enable or disable non-deposition content on the client device; display a deposition session stream on a screen of the client device; and simultaneously enabling or disabling access to the non-deposition pursuant to the instructions from the host device. In some exemplary embodiments, application 106 comprises a set of executable instructions for: accessing a remote deposition in response to activation of a link on an invite from a server or a host device to join the remote deposition, the invite including instructions to access the remote deposition and lock a user interface of a client device during a live video stream of the remote deposition; displaying the live video stream of the remote deposition on the client device; and locking access to the user interface of the client device during the live video stream.

By way of illustration and without limiting the scope of the present invention, these devices are typically situated at different physical locations. For example, the host device 102 may belong to an attorney that has noticed a deposition of a witness and is situated in their office of their law firm; client device 103 may belong to a participant of the deposition such as the attorney of the witness, who would generally be located at their office; client device 104 may be used by the court reporter that will be administering the oath to the witness, and transcribing or preparing the transcript of the deposition; and client device 105 may belong to the witness being deposed and situated at their work office or home. Each of these computing devices typically includes a camera, microphone, speakers and display suitable for live video streaming services, such as live audiovisual communications. Each of these computing devices—host device 102, and client devices 103, 104, and 105 may be configured to access the remote deposition, display the live video stream, and (depending on the instructions in the invite link) lock access to a user interface (display, mouse, keyboard, track pad, etc.) of the client device during the live video stream. Depending on the type of invite received by any one of the client devices 103—105, the client device is either routed via network 107 to server 101 where the remote deposition may be hosted, or alternatively the client device may join the remote deposition and execute instructions that lock a user interface of the client device during a live video stream of the remote deposition. In the illustrated view of FIG. 1, client device 105 is the client device of the witness, and as such this is the only device that is invited to join the deposition with an invitation including the instructions to lock the user interface throughout the duration of the live video stream. Th other client devices 102, 103, and 104, will be able to access a user interface of the respective client device—a mouse, keyboard, touch display, etc.—to allow the user of each device full functionality during the live video stream. This is useful because while the witness may be properly prevented from accessing notes, documents, messages, emails, and other communications during the live video stream during which the witness is being examined, the other participants are typically individuals that may very well require to use their client device. For example, and without deviating front the scope of the present invention, the host device 102 belonging to the deposing attorney will require to be unlocked so that the deposing attorney may present documents or exhibits to the witness. Similarly, the client device 103 belonging to the attorney of the witness (the attorney defending the deposition) will require to be unlocked because defending attorneys often take notes during depositions of their clients or during hearings. Moreover, the client device 104 belonging to the court reporter will require to be unlocked because the court reporter is often using their client device to transcribe the deposition during the live video stream.

Accordingly, in some exemplary embodiments, system 100 may comprise of a server 101 configured to host a remote deposition between a host device 102 and one or more of client devices 103, 104, and 105, wherein one of the client devices is used by a witness to be deposed at the deposition; and an application 106 executable by the client devices 103, 104, and 105, and configured to: receive instructions from the host device 102 or the server 101 to enable or disable non-deposition content on the client device 105; display a deposition session stream on a screen of the client device 105; and simultaneously with the display of the deposition session stream, enabling or disabling access to the non-deposition pursuant to the instructions from the host device.

In some exemplary embodiments, system 100 comprises a server 101 configured to host a remote deposition comprising a live video stream; a host device 102; a client device 105 configured to receive an invite from the server 101 or the host device 102 to join the remote deposition, the invite including a link with instructions to access the remote deposition and lock a user interface of the client device 105 during the live video stream; and an application 106 executable by the client device 105 and configured to: access the remote deposition in response to activation of the link; display the live video stream of the remote deposition on the client device 105, and lock access to the user interface of the client device 105 during the live video stream.

Furthermore, in some exemplary embodiments, one or more of a plurality of client devices (e.g., 103, 104) may be configured to receive a second invite (i.e., or third, or fourth, or nth invite, respectively) from the server or the host device to join the remote deposition, the second invite (i.e., or third, or fourth, or nth invite) including a second link (i.e., or third, or fourth, or nth link) with instructions to access the remote deposition and excluding instructions to lock a user interface of the invited client device during the live video stream. As mentioned above, application 106 may be any type of application, such as a downloadable app, a browser extension, or any other software module including one or more set of executable instructions executable by a client device such as the host device 102 or client devices 103-105. In some exemplary embodiments, service provider 110 provides access to application 106 by way of a software as services platform.

In keeping the integrity of the testimony, for example the witness testimony taken during a remote deposition as described above, and to assist proctoring of the remote deposition, server 101 may be configured to alert a user of the host device 102 (for example, the deposing attorney) if the user interface of the client device of the witness (client device 105) is unlocked during the remote deposition. This may occur for a proper purpose, such as an emergency or in case there is a need to for the witness to access the files with permission of the deposing attorney. To these ends, and to facilitate use of the client device 105 during a live video stream of the remote deposition, application 106 may include a configurable input that enables the user of the client device 105 to unlock their user interface during the live video stream. The configurable input may be a series of keys, a single key, a touch button on their screen, or any other configurable input that unlocks their mouse, keyboard, touch screen display, etc.

For the sake of transparency, and to make sure that this feature is not abused, entering the configurable input to unlock the client device 105 may be recorded by server 101. In turn, in some exemplary embodiments, the server 101 may alert the host device of the act of unlocking the client device but also of the type or event the specific input entered after the client device is unlocked. In this way, if there is a question about impropriety during a deposition, a record may be reviewed to make sure no improper influence of the witness occurred during the remote deposition. Accordingly, in some exemplary embodiments, server 101 may record a user interface input on the client device 105 during the live video stream. In exemplary embodiments, the user interface comprises a keyboard or a mouse and the user interface input comprise a keystroke or a cursor movement; in some exemplary embodiments, the user interface comprises a touch display and the user interface input comprises touch actions on the touch display.

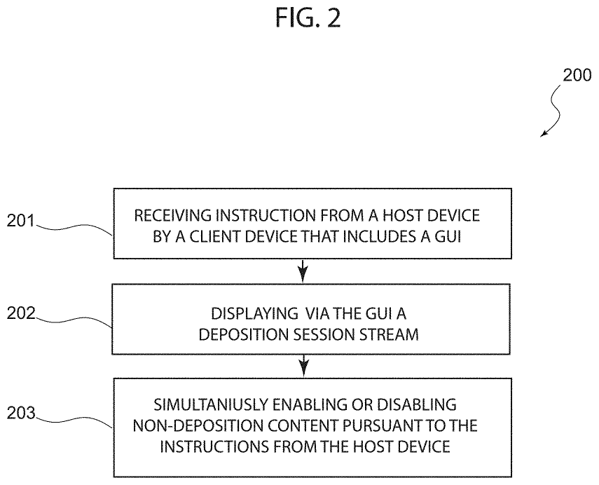

Turning now to the next figure, FIG. 2 illustrates a method in accordance with exemplary embodiments of the present invention. More specifically, FIG. 2 depicts method 200 for monitoring or proctoring testimony from a remote location by way of a graphical user interface (GUI). In some exemplary embodiments, method 200 may include: (201) receiving instructions from a host device to enable or disable non-deposition content on a client device that includes the GUI, the host device and the client device communicating via a server on a network; (202) displaying, via the GUI, a deposition session stream on a screen of the client device; and (203) simultaneously with displaying the deposition session stream, enabling or disabling access to the non-deposition pursuant to the instructions from the host device.

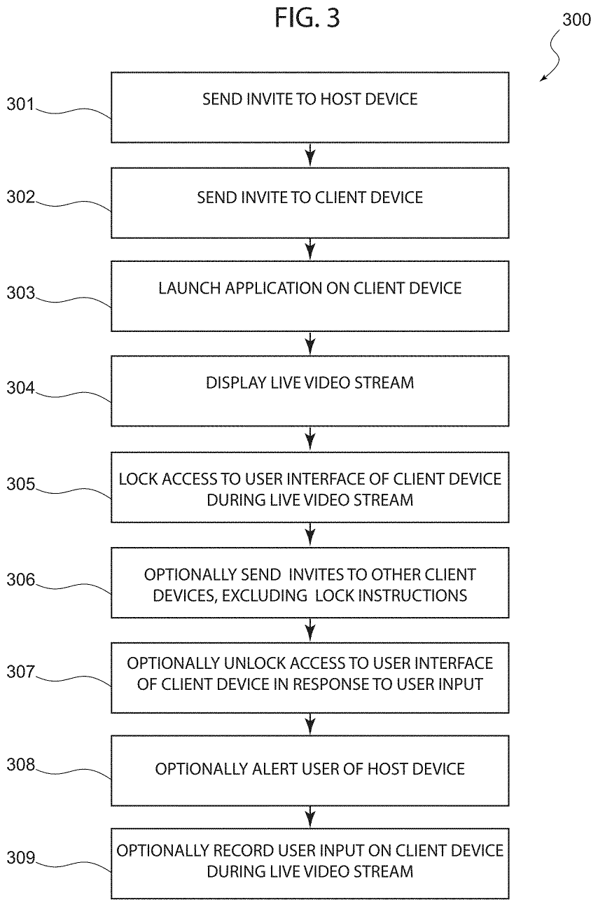

Turning now to the next figure, FIG. 3 illustrates a method performed by a system in accordance with exemplary embodiments of the present invention. More specifically, FIG. 3 illustrates method 300 for proctoring a remote deposition. Although method 300 is illustrated with multiple steps in a particular sequence, it is understood that not all steps may be required and that method 300 (or some of the steps thereof) may be performed optionally and or in alternative sequence without limiting the scope of the present invention.

In step 301, an invite maybe sent to host device 102 from server 101 to join a remote deposition comprising a live video stream. This may be accomplished by an administrator who has been hired or is in charge of scheduling the deposition. For example, service provider 110 may send out invites including to the host device, who may have requested that the remote deposition be scheduled.

In step 302, an invite may be sent to a client device to join the remote deposition, wherein the invite is directed to a witness of the remote deposition. The invite to the client device may include a link with instructions to access the remote deposition and lock a user interface of the client device during the live video stream.

In step 303, the client device may launch an application in response to activation of the link to access the remote deposition.

In step 304, the launched application may display the live video stream of the remote deposition on the client device.

In step 305, the launched application may further lock access to the user interface of the client device during the live video stream.

As mentioned above with reference to FIG. 1, in some exemplary embodiments, a server or host device may optionally, in step 306, send an invite to another client device to join the remote deposition, the invite to the second client device including a second link with instructions to access the remote deposition and excluding instructions to lock a user interface of the second client device during the live video stream. In some exemplary embodiments, in step 307, the client device may unlock the user interface during the live video stream in response to a configurable input on the client device. In step 308, the server may alert a user of the host device if the user interface of the client device is unlocked during the remote deposition. This may be achieved by an application (such as application 106) executable by the client device recording information pertaining to a status of the user interface of the client device and sending that information to the server or to the host device directly. Accordingly, in some exemplary embodiments, in step 309, a user interface input on the client device during the live video stream may be recorded by any one or more of the client device, the server, the host device.

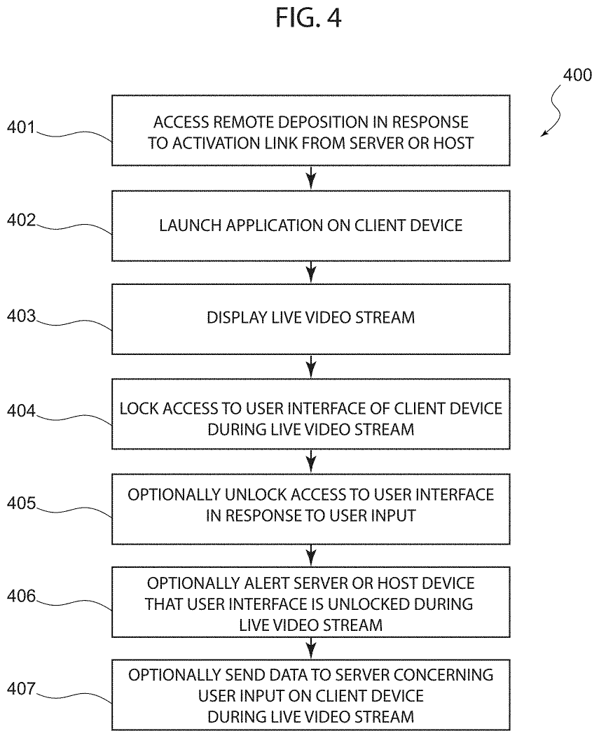

Now turning to the next figure, FIG. 4 illustrates a method performed by a client device in accordance with exemplary embodiments of the present invention. More specifically, FIG. 4 illustrates method 400 for proctoring a remote deposition performed by a client device by way of an application executable by the client device. Although method 400 is illustrated with multiple steps in a particular sequence, it is understood that not all steps may be required and that method 400 (or some of the steps thereof) may be performed optionally and or in alternative sequence without limiting the scope of the present invention.

In step 401, a remote deposition maybe accessed in response to activation of a link on an invite from a server or a host device to join the remote deposition. As mentioned above, depending on the user of the client device (i.e., a witness or a court reporter, or an attorney defending or taking the deposition) the invite may include instructions to access the remote deposition and lock a user interface of a client device during a live video stream of the remote deposition. In the illustrated example, the client device is the client device of a witness being deposed in the remote deposition.

In step 402, the client device may launch an application in response to activation of the link to access the remote deposition.

In step 403, the launched application may display the live video stream of the remote deposition on the client device.

In step 404, subsequently or simultaneously with the display of the live video stream, the client device by way of executable instructions provided by the application may lock access to a user interface of the client device during the live video stream.

In some exemplary embodiments, the client device may optionally, in step 405, the client device may unlock the user interface during the live video stream in response to a configurable input on the client device.

In some exemplary embodiments, the client device may optionally, in step 406, the client device may alert the server or the host device if the user interface of the client device is unlocked during the remote deposition.

In some exemplary embodiments, in step 407, a user interface input on the client device during the live video stream may be recorded by the client device and the data sent to the server for record keeping.

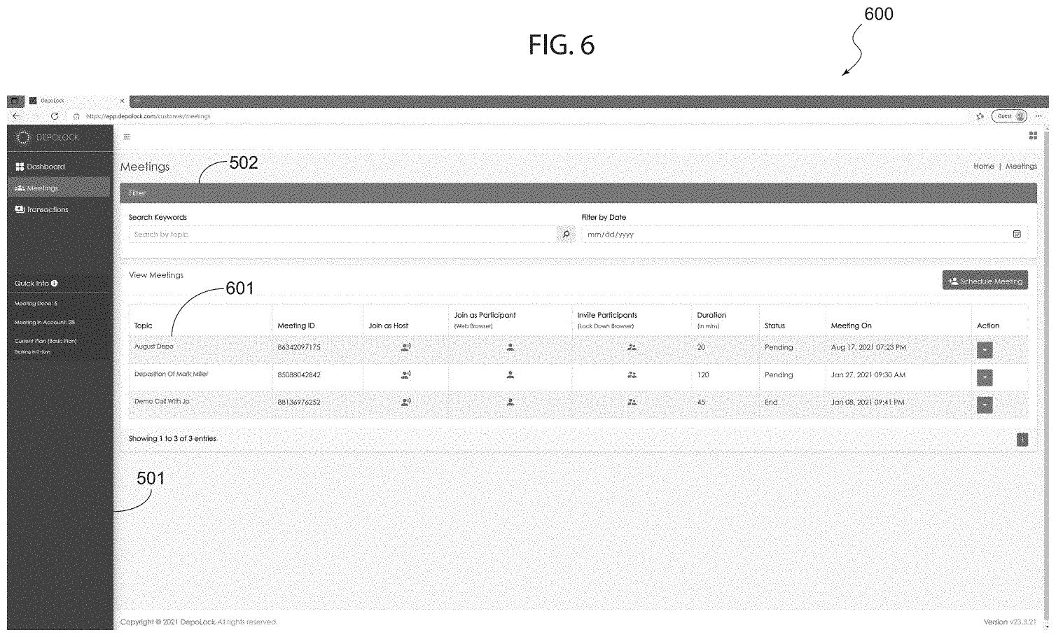

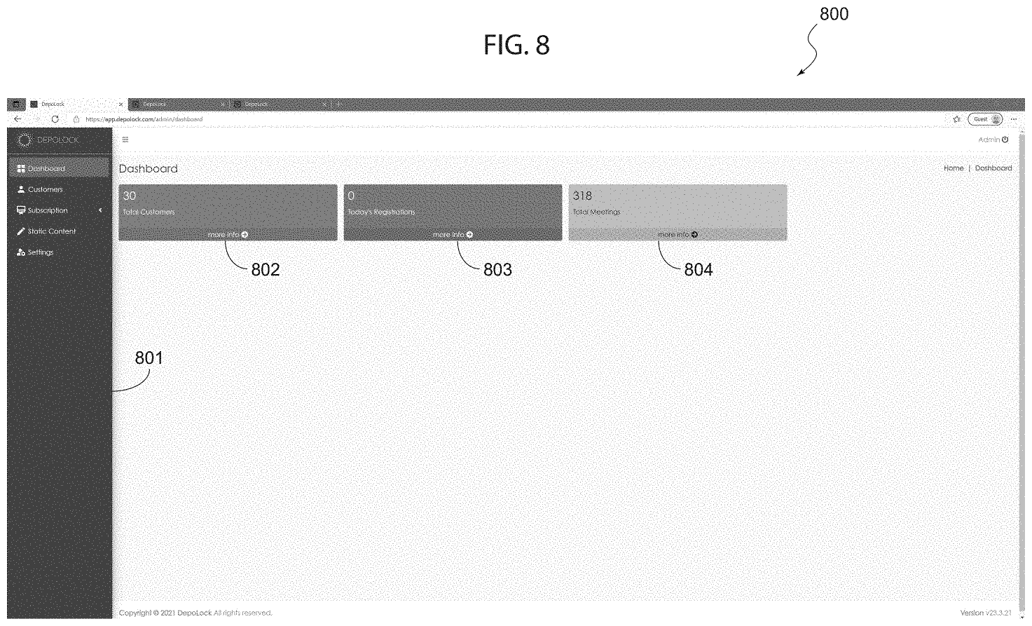

Now turning to the next set of figures, FIG. 5-FIG. 10 illustrate exemplary screen outputs of an application in accordance with the present invention. More specifically, FIG. 5-FIG. 7 illustrate an exemplary customer portal and FIG. 8-FIG. 10 illustrate an exemplary administrator portal in accordance with the present invention. The customer portal 500 illustrated in FIG. 5 shows how in some exemplary embodiments a dashboard 501 may be provided to give access to a variety of tabs, such as account meetings tabs 502 and completed meetings tab 503 for keeping records and track of meetings (for example remote depositions). As may be appreciated by a person of ordinary skill in the art, the GUI may be straightforward and user-friendly utilizing well known elements to facilitate the novel functions of the present invention. By way of example, and without limitation the scope of the present invention, screen output 600 may be an output displayed upon selection of tab 501, which provides the user with a list of scheduled meeting or remote events, including for example remote deposition 601, as shown in FIG. 6.

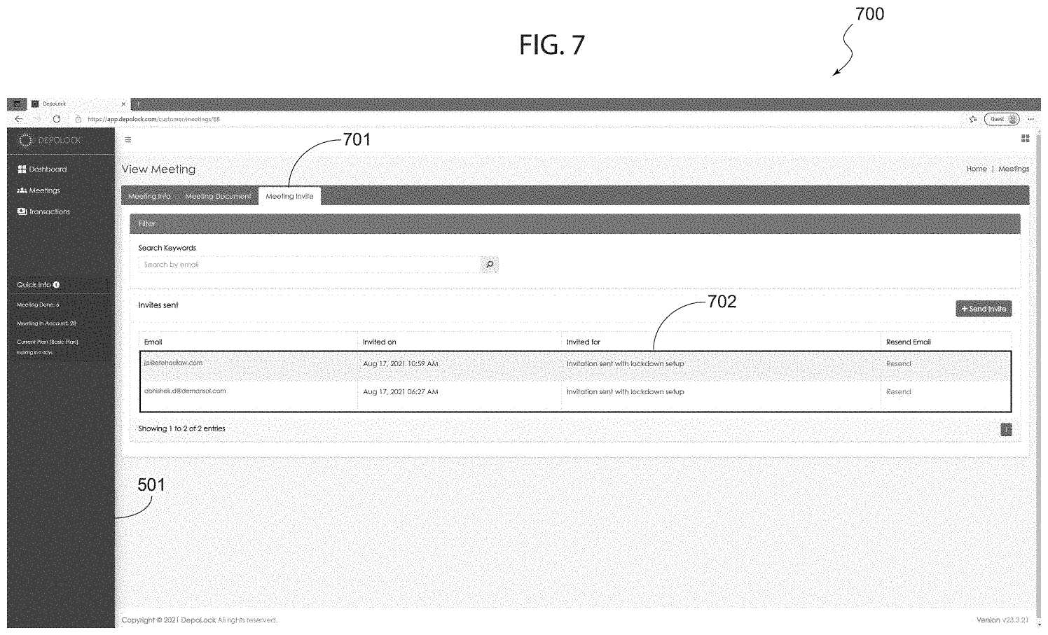

Selecting remote deposition 601, in some exemplary embodiments, may cause the GUI to display output 700 as shown in FIG. 7. In this view, a tab 701 for meeting invites provides access to the invites for the selected remote deposition. The invites displayed in section 702 may include invites with or without a lockdown set up depending on the individuals and their roles in the deposition.

As shown in FIG. 8-FIG. 10, an exemplary administrator portal in accordance with the present invention may facilitate administration of remote events by way of the GUI. For example, in FIG. 8, it may be appreciated that admin portal 800 may also include a similar dashboard 801 may be provided to give access to a variety of tabs, such as total customers tabs 802, a daily registrations tab 803, and a total meeting tab 804 for keeping records and track of the total meetings (for example remote depositions) administered by the service provider. As may be appreciated by a person of ordinary skill in the art, the GUI may be straightforward and user-friendly utilizing well known elements to facilitate the novel functions of the present invention.

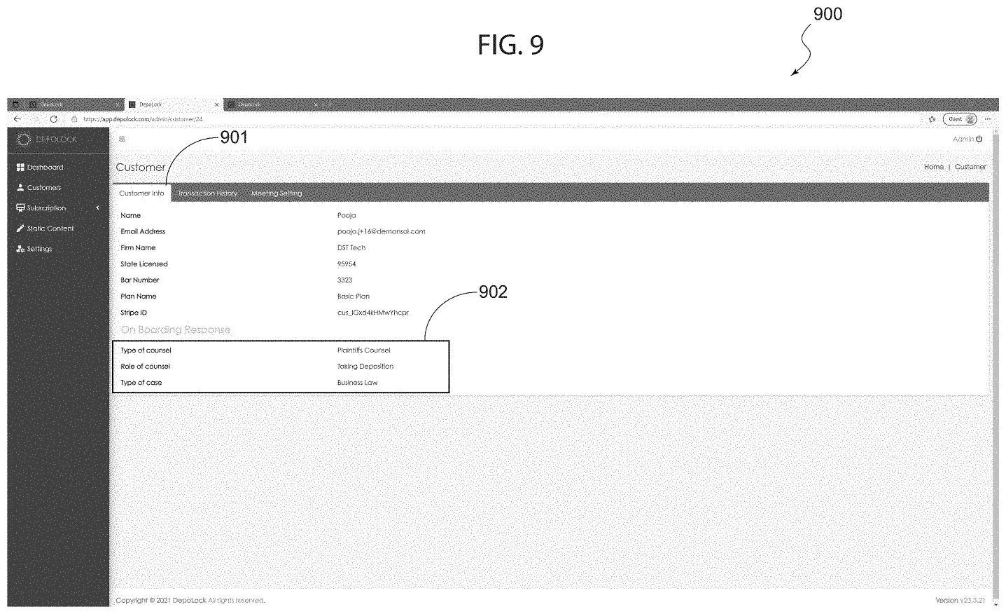

FIG. 9 illustrates a screen output 900, which includes a customer tab 901 for keeping records associated with customers or users of system 100. For example, in addition to keeping information such as contact information of a customer—including email, phone, but also bar number for attorneys, etc. Moreover, information such as the role of the customer may also be stored using this portion of the GUI, which may be useful in determining (in some embodiments automatically) the type of invite to be issued to the customer or their invitees. For example, and without limiting the scope of the present invention, in some exemplary embodiments, indicating under tab 902 that the role of the customer (i.e., a plaintiff taking a deposition, a defendant taking a deposition, or an attorney (plaintiff or defendant) defending the deposition) may automatically generate a correlating invite to their invitee. If for example a customer is taking a deposition of a witness, the information in tab 902 may be used by system 100 to automatically generate a link including instructions to lock a client device's user interface, whenever the link is being sent to a witness invitee. Similarly, if the link is being sent to a non-witness invitee (such as a defending attorney) the instructions on the link to lock a user interface of the client device may be omitted. In some embodiments, this may o course be achieved manually without deviating from the scope of the present invention.

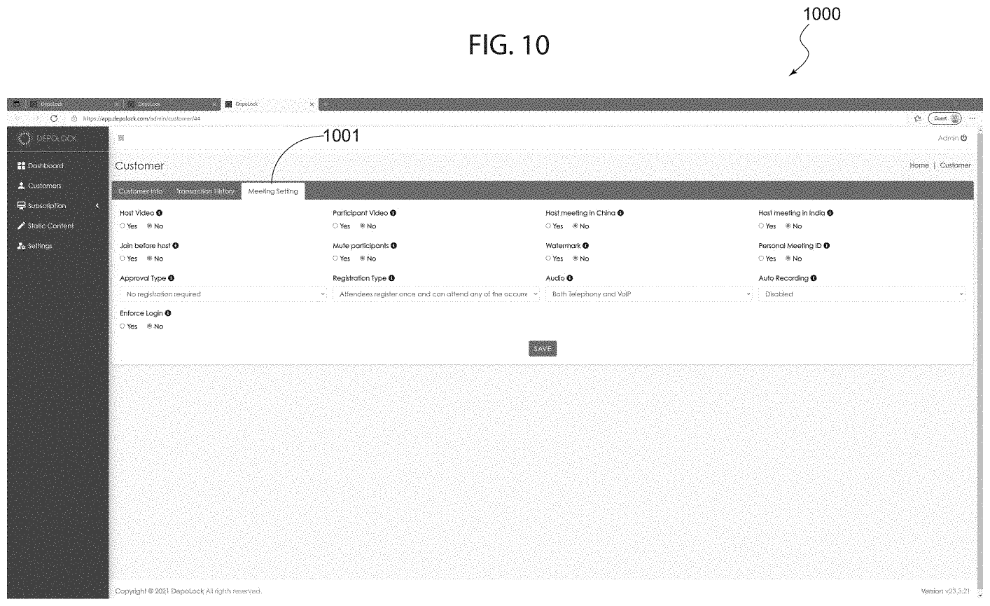

FIG. 10 illustrates a screen output 1000, which includes a meeting settings tab 1001 for setting options and or functions that may be available for a meeting administered through system 100. Meeting settings tab 1001 may be another user-friendly means of setting or indicating the type of invite that is sent out to a participant and or user of system 100.

Various features and a variety of functions may be provided via the application or GUI. For example, and without limiting the scope of the present invention, the following functions may be facilitated:

Computer/Monitor Lock: The present invention may be designed to lock the deponent's computer/monitor and restrict access to nothing but the deposition in progress (i.e. non-deposition content) during the deposition (i.e. the deposition session stream). This may allow the deponent to communicate with the party taking the deposition and the deponent's counsel or party proponent, openly, and in the presence of all parties. This may be achieved in any number of ways. In one embodiment, this is achieved merely by locking a screen but without making any changes to a registry of the client device. This makes the application less intrusive, more efficient, and less expensive to develop.

Deponent Positioning: The GUI may include instructions for a deponent to position themselves far enough back so all parties will have in full view the deponent's desk or surface containing the deponent's computer, the deponent's upper body extremities, and all electronic devices (which may be turned off during the deposition).

Deponent's Statement of Truth: The deponent may be asked to confirm that there are no other devices to which the deponent can access during the deposition. This statement will be provided through an on-screen prompt and disclosure that the deponent must click, confirm, and submit.

Buttons & Controls: The deponent may be provided access, via the GUI, to buttons alerting all parties of “No Sound,” “No Video,” “Raise A Question,” “Connection Issue,” and “Statement of Truth (only at the onset).”

Computer Mouse/Keyboard: The deponent may be provided access to volume and chat (openly and in the presence of all parties) primarily for troubleshooting issues.

Document Bank for Exchange: The present invention may be designed to have a document bank for the seamless collection and distribution of all materials related to the deposition. This document bank will enable all parties access to materials required for disclosure by either party as determined by relevant statute. Documents cannot be added contemporaneous to the deposition unless agreed upon by all parties.

Host/Requesting Party: The present invention may be designed to enable the host, the party requesting to take the deposition, to control whether the deponent can lock or unlock the deponent's computer/monitor.

Communication with Deponent: The present invention may be designed to eliminate latent communication with the deponent and their counsel or party proponent, however, if counsel or the party proponent wishes to confer with the deponent, as in an in-person deposition, that party may request to communicate with the deponent privately and such request may be granted by all parties.

Recording: The present invention may be designed to record the deposition in its entirety and will provide each party a copy of the recording within the statutory period.

Third-party application Integration: The present invention may be designed to be integrated with third-party platforms. For example, and in no way limiting the scope of the present invention, the present invention may be optimized for the Zoom platform within a Zoom application.

Invitation: In exemplary embodiments, the host may initiate the deposition invites to all parties subject to the deposition and will as such have sole responsibility of this task.

Deposition History: In exemplary embodiments, each deposition may be logged, and proof will be provided on each user's dashboard or history log. Each deposition will provide the exact day, date, time, duration, parties, and deponent information along with which court reporting service engaged in preparing the deposition transcript with all relevant contact information of all parties.

As may be appreciated by one skilled in the art, many variations on a system and method for proctoring testimony in accordance with the present disclosure may be achieved without deviating from the scope of the invention. For example, in some exemplary embodiments, the present invention may be commercialized by way of a subscription-based business model. In such exemplary embodiment, all parties may have the option of joining as a guest or establishing an account. The account may provide subscription options for each user or company of users.

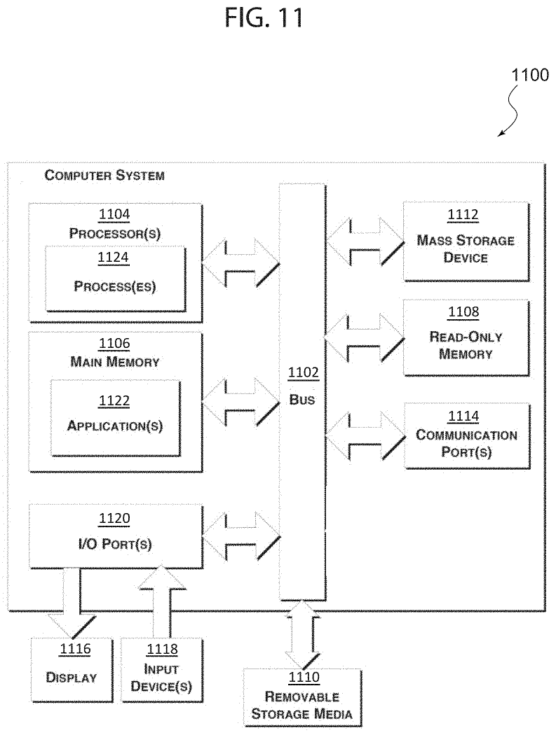

FIG. 11 illustrates aspects of computing and computer devices in accordance with exemplary embodiments of the present invention. More specifically, FIG. 11 is a schematic diagram of a typical computing device, which in accordance with the present invention may be a host device or a client device, or a computing device used for administration purposes a service provider of a system in accordance with the present invention. Thus, in this view, a block diagram of an exemplary computer device 1100 upon which embodiments of the present disclosure may be implemented and carried out is shown.

According to the present example, the computer device 1100 includes a bus 1102 (i.e., interconnect), one or more processors 1104, one or more communications ports 1114, a main memory 1106, removable storage media 1110, read-only memory 1108, and a mass storage 1112. Communication port(s) 1114 may be connected to one or more networks by way of which the computer device 1100 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1104 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 1114 can be any of an RS-232 port for use with a modem-based dial-up connection, a 10/100 Ethernet port, a Gigabit port using copper or fiber, or a USB port, and the like. Communications port(s) 1114 may be chosen depending on a network such as a Local Area Network (LAN), a Wide Area Network (WAN), a CDN, or any network to which the computer device 1100 connects. The computer device 1100 may be in communication with peripheral devices (e.g., display screen 1116, input device(s) 1118, such as a mouse or keyboard or combination device thereof) via Input/Output (I/O) port 1120. Some or all of the peripheral devices may be integrated into the computer device 1100, and the input device(s) 1118 may be integrated into the display screen 1110 (e.g., in the case of a touch screen).

Main memory 1106 can be Random Access Memory (RAM), or any other dynamic storage device(s) commonly known in the art. Read-only memory 1108 can be any static storage device(s) such as Programmable Read-Only Memory (PROM) chips for storing static information such as instructions for processor(s) 1104. Mass storage 1112 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 1102 communicatively couples processor(s) 1104 with the other memory, storage and communications blocks. Bus 1102 can be a PCI/PCI-X, SCSI, a Universal Serial Bus (USB) based system bus (or other) depending on the storage devices used, and the like. Removable storage media 1110 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor, or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards, or protocols; and/or (iv) encrypted in any of a variety of ways well known in the art.

A computer-readable medium can store (in any appropriate format) those program elements that are appropriate to perform the methods.

As shown, main memory 1110 is encoded with application(s) 1122 that support(s) the functionality as discussed herein (an application 1122 may be an application that provides some or all of the functionality of one or more of the mechanisms described herein). Application(s) 1122 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1104 accesses main memory 1106 via the use of bus 1102 in order to launch, run, execute, interpret or otherwise perform the logic instructions of the application(s) 1122. Execution of application(s) 1122 produces processing functionality of the service(s) or mechanism(s) related to the application(s). In other words, the process(es) 1124 represents one or more portions of the application(s) 1122 performing within or upon the processor(s) 1104 in the computer device 1100.

It should be noted that, in addition to the process(es) 1124 that carries(carry) out operations as discussed herein, other embodiments herein include the application 1122 itself (i.e., the un-executed or non-performing logic instructions and/or data). The application 1122 may be stored on a computer readable medium (e.g., a repository) such as a disk or in an optical medium. According to other embodiments, the application 1122 can also be stored in a memory type system such as in firmware, read only memory (ROM), or, as in this example, as executable code within the main memory 1106 (e.g., within Random Access Memory or RAM). For example, application 1122 may also be stored in removable storage media 1106, read-only memory 1108, and/or mass storage device 1112.

Those of ordinary skill in the art will understand that the computer device 1100 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

A system and method for proctoring testimony has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A method for proctoring a remote deposition, comprising:
sending an invite to a host device to join a remote deposition comprising a live video stream;
sending an invite to a client device to join the remote deposition, the invite to the client device including a link with instructions to access the remote deposition and lock a user interface of the client device during the live video stream;
launching an application on the client device in response to activation of the link to access the remote deposition, including:
displaying the live video stream of the remote deposition on the client device, and
locking access to the user interface of the client device during the live video stream.

2. The method of claim 1, wherein:
sending an invite to a second client device to join the remote deposition, the invite to the second client device including a second link with instructions to access the remote deposition and excluding instructions to lock a user interface of the second client device during the live video stream.

3. The method of claim 1, further comprising:
unlocking the user interface during the live video stream in response to a configurable input on the client device.

4. The method of claim 1, further comprising:
alerting a user of the host device if the user interface of the client device is unlocked during the remote deposition.

5. The method of claim 1, further comprising:
recording a user interface input on the client device during the live video stream.

6. The method of claim 5, wherein:
the user interface comprises a keyboard or a mouse and the user interface input comprises a keystroke or a cursor movement.

7. The method of claim 1, wherein:
the user interface comprises a touch display and the user interface input comprises touch actions on the touch display.

8. A system for proctoring a remote deposition, comprising:
a server configured to host a remote deposition comprising a live video stream;
a host device;
a client device configured to receive an invite from the server or the host device to join the remote deposition, the invite including a link with instructions to access the remote deposition and lock a user interface of the client device during the live video stream; and
an application executable by the client device and configured to:
access the remote deposition in response to activation of the link;
display the live video stream of the remote deposition on the client device, and
lock access to the user interface of the client device during the live video stream.

9. The system of claim 8, further comprising:
a second client device configured to receive a second invite from the server or the host device to join the remote deposition, the second invite including a second link with instructions to access the remote deposition and excluding instructions to lock a user interface of the second client device during the live video stream.

10. The system of claim 8, wherein the application is further configured to:
unlock the user interface during the live video stream in response to a configurable input on the client device.

11. The system of claim 8, wherein the application is further configured to:
alert a user of the host device if the user interface of the client device is unlocked during the remote deposition.

12. The system of claim 8, wherein the application is further configured to:
record a user interface input on the client device during the live video stream.

13. The system of claim 12, wherein:
the user interface comprises a keyboard or a mouse and the user interface input comprises a keystroke or a cursor movement.

14. The system of claim 12, wherein:
the user interface comprises a touch display and the user interface input comprises touch actions on the touch display.

15. A method for proctoring a remote deposition, comprising:
accessing a remote deposition in response to activation of a link on an invite from a server or a host device to join the remote deposition, the invite including instructions to access the remote deposition and lock a user interface of a client device during a live video stream of the remote deposition;
displaying the live video stream of the remote deposition on the client device, and
locking access to the user interface of the client device during the live video stream.

16. The method of claim 15, further comprising:
unlocking the user interface during the live video stream in response to a configurable input on the client device.

17. The method of claim 15, further comprising:
alerting a user of the host device if the user interface of the client device is unlocked during the remote deposition.

18. The method of claim 15, further comprising:
sending data to the server concerning a user interface input on the client device during the live video stream.

19. The method of claim 18, wherein:
the user interface comprises a keyboard or a mouse and the user interface input comprises a keystroke or a cursor movement.

20. The method of claim 18, wherein:
the user interface comprises a touch display and the user interface input comprises touch actions on the touch display.
